(19) United States
(12) Patent Application Publication
(10) Pub. No.: US 2014/0320529 A1
(43) Pub. Date: Oct. 30, 2014

(54) VIEW STEERING IN A COMBINED VIRTUAL AUGMENTED REALITY SYSTEM

(71) Applicant: PALO ALTO RESEARCH CENTER INCORPORATED, Palo Alto, CA (US)

(72) Inventors: Michael Roberts, Los Gatos, CA (US); Maurice K. Chu, Burlingame, CA (US)

(73) Assignee: Palo Alto Research Center Incorporated, Palo Alto, CA (US)

(21) Appl. No.: 13/871,990

(22) Filed: Apr. 26, 2013

(51) Int. Cl. G06T 19/00

(52) U.S. Cl. CPC G06T 19/006
USPC 345/633

(57) ABSTRACT

One embodiment of the present invention provides a system for assisting view-steering from a remote client machine. During operation, the system receives, at a local client from a collaboration server, a view-synchronization request for synchronizing a local scene displayed on the local client with a remote scene displayed on the remote client; generates, at the local client, a view-steering widget based on the view-synchronization request; and displays the view-steering widget on top of the local scene, thereby facilitating a local user of the local client to update the local scene displayed on the local machine in order to match the local scene to at least a portion of the remote scene displayed on the remote client machine.

### BACKGROUND

1. Field

This disclosure is generally related to a remote servicing system. More specifically, this disclosure is related to a video-enabled remote-servicing system that allows a remote user to direct a local user to steer the view of a camera.

2. Related Art

Remote servicing of complex equipment has gained popularity recently because it offers customers several advantages, including reduced response time and lowered maintenance and repair costs. In one remote servicing scenario, an expert technician of the equipment vendor can remotely assist and train an on-site novice (usually a maintenance staff member of the customer) to perform repairs or maintenance on a piece of equipment. This often requires remote, real-time interaction between the expert and the novice, during which the expert instructs the novice how to physically manipulate the equipment. Such interaction requires an exchange of detailed, real-time information about the equipment and maneuvers of the novice. Conventional communication techniques, such as phone calls or video conferencing, are not adequate in facilitating such interaction.

### SUMMARY

One embodiment of the present invention provides a system for assisting view-steering from a remote client machine. During operation, the system receives, at a local client from a collaboration server, a view-synchronization request for synchronizing a local scene displayed on the local client with a remote scene displayed on the remote client; generates, at the local client, a view-steering widget based on the view-synchronization request; and displays the view-steering widget on top of the local scene, thereby facilitating a local user of the local client to update the local scene displayed on the local machine in order to match the local scene to at least a portion of the remote scene displayed on the remote client machine.

In a variation on this embodiment, the remote client runs a virtual reality (VR) application that displays the remote scene.

In a further variation, the view-synchronization request comprises one or more of: a location and an orientation of an object within the remote scene, and view information associated with the remote scene.

In a variation on this embodiment, the local client runs an augmented reality (AR) application, and the local scene comprises at least a video scene captured by a camera coupled to the local client.

In a further variation, displaying the view-steering widget involves overlaying the view-steering widget on the video scene, and the view-steering widget indicates one or more of: a direction of the camera, and a distance of the camera.

In a variation on this embodiment, the view-steering widget includes one or more of: peripheral dots, an arrow, a gimbal, a mini map, a polygon pipe, and a cone.

In a variation on this embodiment, in response to determining that the local scene has been updated to match the portion of the remote scene, the system transmits an image of the local scene to the remote client.

### BRIEF DESCRIPTION OF THE FIGURES

FIG. 1 presents a diagram illustrating an exemplary video-enabled collaboration system, in accordance with an embodiment of the present invention.

FIG. 2A presents a diagram illustrating exemplary views of display windows for the virtual reality (VR) and augmented reality (AR) applications, in accordance with an embodiment of the present invention.

FIG. 2B presents a diagram illustrating an exemplary view of the AR display window, in accordance with an embodiment of the present invention.

FIG. 2C presents a diagram illustrating an exemplary view of the AR display window, in accordance with an embodiment of the present invention.

FIG. 2D presents a diagram illustrating an exemplary view of the AR display window, in accordance with an embodiment of the present invention.

FIG. 3 presents a diagram illustrating the architecture of an exemplary video-enabled collaboration server, in accordance with an embodiment of the present invention.

FIG. 4 presents a diagram illustrating the architecture of an exemplary virtual reality client, in accordance with an embodiment of the present invention.

FIG. 5 presents a diagram illustrating the architecture of an exemplary augmented reality client, in accordance with an embodiment of the present invention.

FIG. 6 presents a time-space diagram illustrating the view-steering process, in accordance with an embodiment of the present invention.

FIG. 7 illustrates an exemplary computer system for view-steering in a VR/AR combined system, in accordance with one embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system that runs a collaborative video application between a local user performing a service and a remote expert user providing service instructions to the local user. More specifically, the local user runs an Augmented Reality (AR) application that obtains real-time videos from a camera, and interacts with the remote expert user who runs a Virtual Reality (VR) application. During operation, the remote expert user may direct the local user to steer his camera to a desired angle or location by manipulating an object in the VR environment. The collaboration video application sends location and view information of the object to the AR application, which in turn overlays a “view-steering” widget on the video. The “view-steering” widget facilitates the local user in steering the AR camera until the desired effect is achieved.

### Video-Enabled Collaboration System

During conventional assisted servicing of a complicated device, an expert technician is physically collocated with a novice to explain and demonstrate by physically manipulating the device. However, this approach to training or assisting the novice can be expensive and time-consuming because the expert technician often has to travel to a remote location where the novice and the device are located.

Remotely assisted servicing allows an expert to instruct a trainee or a novice remotely, thus significantly lowering the repair or maintenance costs of sophisticated equipment. During a remote servicing session, the novice physically manipulates the equipment; the expert, although not present physically, can provide instructions or give commands using a certain communication technique from a remote location. However, the information that can be exchanged using existing communication techniques is often inadequate for such remotely assisted servicing. For example, during a conference call audio, video, and text or graphical content are typically exchanged by the participants, but three-dimensional spatial relationship information, such as the spatial interrelationship among components in the device (e.g., how the components are assembled) is often unavailable. This is a problem because the remote expert technician does not have the ability to point and physically manipulate the local device during a remote servicing session. Furthermore, the actions of the novice are not readily apparent to the remote expert technician unless the novice is able to effectively communicate his actions. Typically, relying on the novice to verbally explain his actions to the remote expert technician and vice versa is not effective because there is a significant knowledge gap between the novice and the remote expert technician. Consequently, it is often difficult for the remote expert technician and the local novice to communicate regarding how to perform servicing tasks.

Current AR systems for remote servicing often ignore such problems because most them are inherently single user systems and are restricted in space to dealing with modest-sized objects. Other AR systems, such as the one implemented in video game systems, may provide a way of steering a user to points of interest. For example, some video games may display a “mini-map” to lead the user to find a particular item. However, such systems do not provide a way to steer the view of an AR camera and synchronize it to a view of an object in a corresponding virtual environment.

Embodiments of the present invention provide a video-enabled collaboration system that allows a remote user to steer the view of a camera operated by a local user. More specifically, a local user servicing a piece of equipment uses an AR system that includes a video camera for recording live video streams, and the remote expert uses a VR system that interacts with the local user and receives the live video streams or images from the videos via the video-enabled collaboration system. When the remote expert wishes to “view” a particular component of the equipment from a particular angle, the remote expert can instruct the local user to steer the AR camera to a particular location at a particular angle. Note that, when viewing a complicated piece of equipment, such “view-steering” instructions cannot be easily conveyed verbally. In embodiments of the present invention, the remote expert “steers” the view of the AR camera by manipulating an object, which corresponds to the desired component for viewing, in the VR system to a desired angle. For example, the remote expert may select an object of interest or position his view appropriately, via an input mechanism, such as a mouse, a keyboard, VR headset tracker, or other input devices. Upon the request of the remote expert, the VR system sends the location of the object being manipulated or the view information to the collaboration server, which in turn sends the view-steering request and the associated information to the AR system. Upon receiving the view-steering request, the AR system generates a view-steering widget based on the received information, and overlays the widget onto the video from the scene being tracked, thus assisting the local user in adjusting the viewpoint of the camera to the desired location.

In the discussion that follows, a virtual environment (which is also referred to as a ‘virtual world’ or ‘virtual reality’ application) should be understood to include an artificial reality that projects a user into a space (such as a three-dimensional space) generated by a computer. Furthermore, an augmented reality application should be understood to include a live or indirect view of a physical environment whose elements are augmented by superimposed computer-generated information (such as supplemental information, an image or information associated with a virtual reality application).

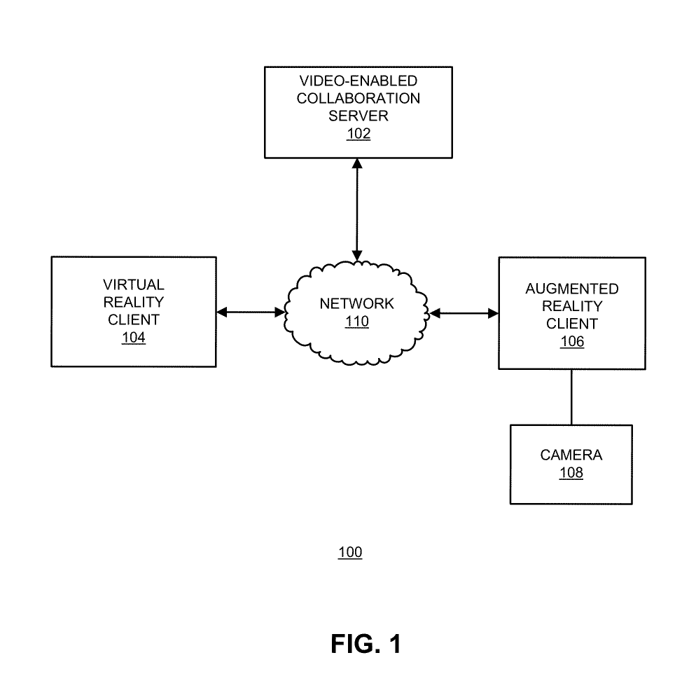

FIG. 1 presents a diagram illustrating an exemplary video-enabled collaboration system, in accordance with an embodiment of the present invention. Video-enabled collaboration system 100 includes a video-enabled collaboration server 102, a virtual reality (VR) client 104, an augmented reality (AR) client 106, a camera 108, and a network 110.

Video-enabled collaboration server 102 interacts with both VR client 104 and AR client 106 via network 110. In some embodiments, video-enabled collaboration server 102 maintains a world model that represents the state of one or more computer-generated objects that are associated with one or more physical objects in the real world. Note that the world model may correspond to a two- or three-dimensional space, or a hyper-geometric space that corresponds to multiple parameters, such as a representation of stock trading or the function of a power plant.

VR client 104 displays a virtual environment to its user, such as an expert. In some embodiments, VR client 104 can be an electronic device that interacts with video-enabled collaboration server 102, keeps the displayed state of the one or more objects in the virtual reality application synchronized with the world model, and displays the objects in the virtual reality application. In one embodiment, VR client 104 displays the virtual reality application using a multi-dimensional rendering technique. Furthermore, VR client 104 can capture interactions of its users, such as an expert, with the objects in the virtual reality application, such as users' selections, gestures, and view-steering instructions, and can relay these interactions to video-enabled collaboration server 102, which in turn updates the world model as needed and distributes the view-steering instructions to augmented reality client 106.

AR client 106 can be an electronic device that can capture real-time video using camera 108, and display information or images associated with the world model (such as specific objects, assembly instructions, gesture information from the expert user of VR client 104, etc.) along with the captured video (including overlaying and aligning the information and images, such as a view-steering widget, with the captured video). Moreover, AR client 106 is capable of receiving view-steering instructions from VR client 104 via video-enable collaboration server 102. In response to receiving the view-steering instructions, AR client 106 overlays a view-steering widget in the scene of the video, thus facilitating the user of AR client 106 to adjust the view of the AR camera accordingly.

During a remote-servicing session, an expert technician who is using VR client 104 can remotely train a novice who is using AR client 106. (Alternatively, the expert technician may use AR client 106 and the novice may use VR client 104; or they may both use an AR client.) Note that the VR environment may include computer-generated models (such as computer-aided design (CAD) models) associated with one or more physical objects in the AR environment. For example, when servicing a car engine, VR client 104 may display a CAD model of the car engine, and AR client 106 may display the real-time video feed of the car engine being serviced.

In the process, the novice is operating a camera for capturing videos reflecting the real-world scenes (such as the equipment being serviced). The videos are loaded into the AR application running on AR client 106, which performs the appropriate AR functions, such as feature extraction and object tracking. The tracking information can be uploaded from AR client 106 to video-enabled collaboration server 102. The videos can be viewed in real time by the expert technician using VR client 104.

While viewing the videos, in order to give an accurate instruction to the novice, the expert technician may wish to view a particular object at a particular angle. The object may be out of the current view of the camera, or may be viewed at a different angle by the camera. In conventional systems, the expert technician may verbally instruct the novice to adjust his camera to the left, right, up, or down until the desired view is obtained. As one can see, such verbal instructions are neither accurate nor effective. In embodiments of the present invention, the view-steering instructions are presented to the novice by the AR client 106 using a widget, which can be a small, stand-alone application. In one embodiment, the widget takes the form of an on-screen device, such as peripheral dots (which are often used on video game environments) or arrows. For example, if the object of interest is out of the current view of the camera, AR client 106 overlays peripheral dots on the current video scene (often at the edges of the display window), indicating to the novice that the camera should be adjusted to bring the object into view. Alternatively, if the object of interest is viewed at an angle that is different from the desired viewing angle, AR client 106 overlays an arrow on the selected object, indicating the direction in which the object should be turned. Note that the widget can take different forms, as long as it can assist the AR user in adjusting the view of the camera. In one embodiment, the widget can be a simple circle around a selected object, indicating to the camera holder that he needs to place the circled object into the center view of the camera.

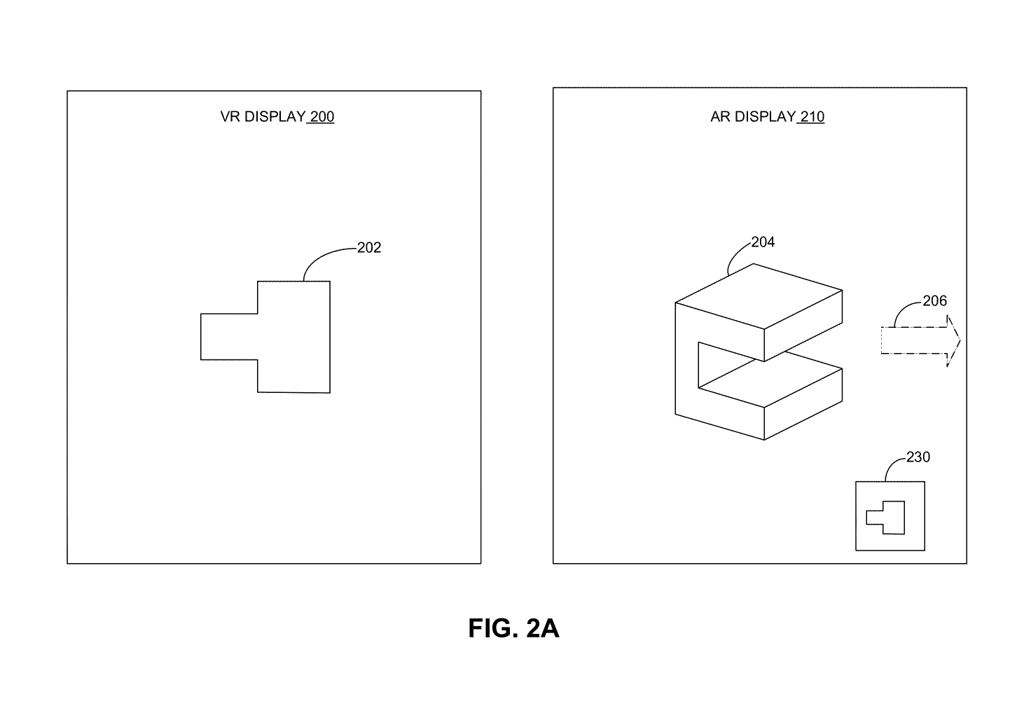

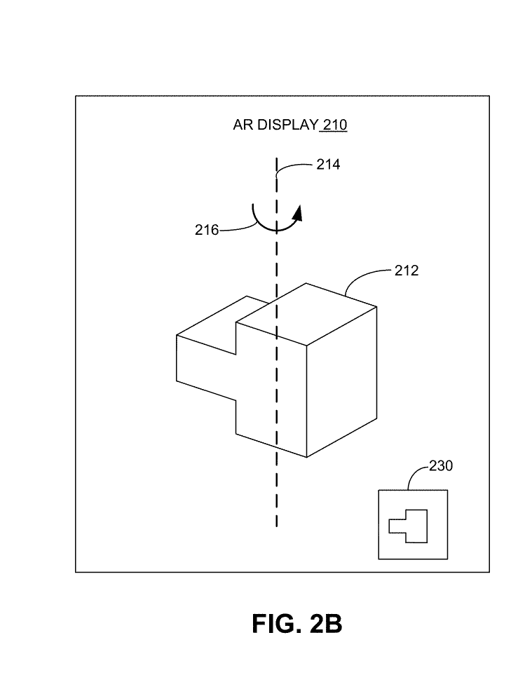

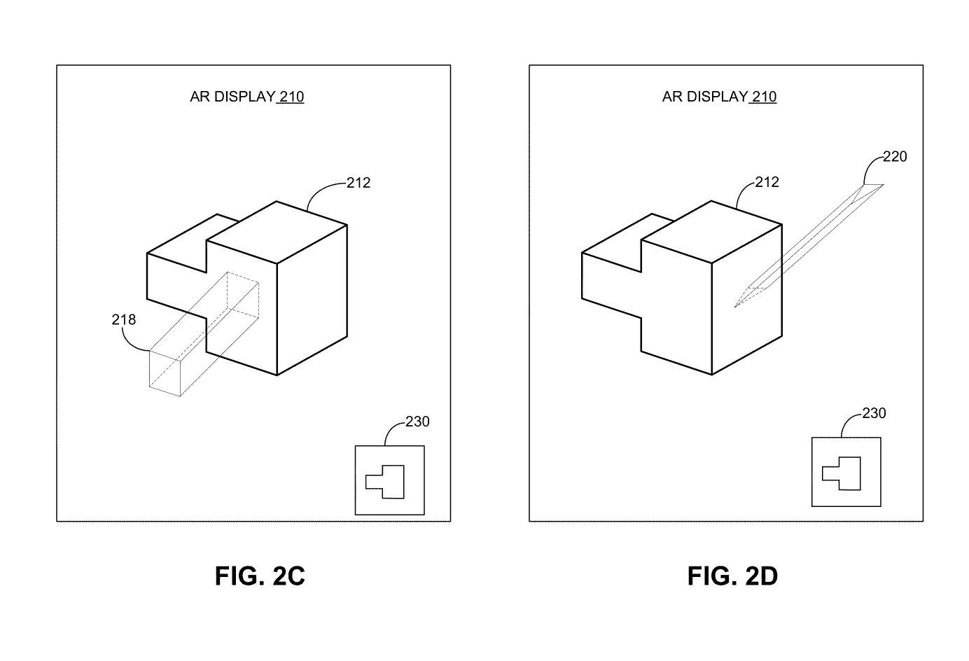

FIG. 2A presents a diagram illustrating exemplary views of display windows for the VR and AR applications, in accordance with an embodiment of the present invention. The left-hand drawing illustrates an exemplary VR display window 200, which includes an object 202 in the virtual environment. The user of the VR application can manipulate object 202 by selecting object 202 and turning object 202 to a desired viewpoint. In the example shown in FIG. 2A, object 202 is turned to allow the user to have an orthogonal view of the front surface of object 202. Note that the VR application allows the user to drag the object to different locations or rotate it to different angles. The user of the VR application can then request the corresponding AR application to sync the view of its camera to the view shown in VR display 200. In response to such a request, the VR application sends the location and the viewing angle of object 202 to the collaboration server, which forwards such information to the AR application.

The right-hand drawing of FIG. 2A illustrates an exemplary AR display window 210, which displays an augmented reality based on videos captured in real time. In the example shown in FIG. 2A, the real-world counterpart of object 202 is out of the camera view. AR display 210 displays the current camera view, which includes a real-world object 204, which is located to the left of the real-world counterpart of object 202. To indicate to the AR user that he needs to move the camera to the right to bring the real-world counterpart of object 202 into view, AR display 210 also displays view-steering widget, such as an arrow 206 pointing to the right. Optionally, AR display 210 can also display a small window 230 at its corner. Small window 230 may display the screenshot of VR display 200, thus indicating to the AR user the selected object and how the expert wants to align the camera. In addition to arrows and peripheral dots, other visual aids that can direct the user in bringing the selected object into the current view are also possible. In some embodiments, AR display 210 may also display a mini map (not shown in FIG. 2A) with zooming capabilities to allow the user to find the location of the selected object relative to the current camera view.

Once the desired object is in view, other forms of view-steering widgets may be displayed to assist the AR user in adjusting the viewing angle of the camera until the desired effect is achieved. FIG. 2B presents a diagram illustrating an exemplary view of the AR display window, in accordance with an embodiment of the present invention. In the example shown in FIG. 2B, AR display 210 displays a physical object 212, which is the real-world counterpart of object 202 in VR display 200 and is turned sideways under the current camera view. To synchronize the view of the AR application to that of the VR application, that is to adjust the view of the AR camera such that object 212 is displayed in AR display 210 exactly the same way as object 202 in VR display 200, AR display 210 displays a widget which includes a rotation axis 214 and an arrow 216. Axis 214 and arrow 216 collectively indicate to the user of the AR application that he needs to adjust the camera in such a way that object 212 rotates around rotation axis 214 in the direction indicated by arrow 216. In addition to axes and arrows, other types of view-steering visual aids, such as a gimbal, can also be used to assist a user in adjusting the view of the camera. In one embodiment, when working with a relatively large object, such as a vehicle or a ship, the system may use an avatar (dropped in the VR environment) to indicate where the user should stand and face, as well as how to tilt his head. The VR screenshot that includes the avatar can then be sent to and displayed on the AR client, thus assisting the AR user in adjusting the camera location and viewing angle.

In one embodiment, once object 212 is approximately aligned, the AR application may change into a more accurate alignment mode by displaying a different widget, which can be a stick, on top of object 212. FIG. 2C presents a diagram illustrating an exemplary view of the AR display window, in accordance with an embodiment of the present invention. In FIG. 2C, AR display 210 displays object 212 and a “stick” widget 218 projecting out of object 212. Note that stick widget 218 not only indicates the selected object and the orientation of the view, but also the height of the camera above the object. More specifically, to align object 212 to the desired camera view, the user just needs to position his camera in such a way that it is looking “down” stick widget 218 toward object 212, from the top of stick widget 218. Note that, as the camera is being adjusted, the orientation and the height of stick widget 218 change accordingly to lead the user to the desired camera view. Stick widget 218 may have various geometric forms. In the example shown in FIG. 2C, stick widget 218 is displayed as a hollow square pipe. Other types of polygonal pipes or cones are also possible. FIG. 2D presents a diagram illustrating an exemplary view of the AR display window, in accordance with an embodiment of the present invention. In the example shown in FIG. 2D, a stick widget 220 is displayed on top of object 212, indicating the desired viewing angle and height of the camera. In FIG. 2D, stick widget 220 is a hollow triangular pipe. In some embodiments, special effects can be applied, such as displaying the stick widget as a semi-transparent object, to indicate that the stick widget is a computer-generated object and is not part of the real-world scene. Once the AR camera has been moved to the desired location, the AR client may perform an action, such as capturing a high-resolution image of the view. This image can be transmitted to the VR client via the collaboration server. The VR client can then display such an image in the VR environment for the expert user.

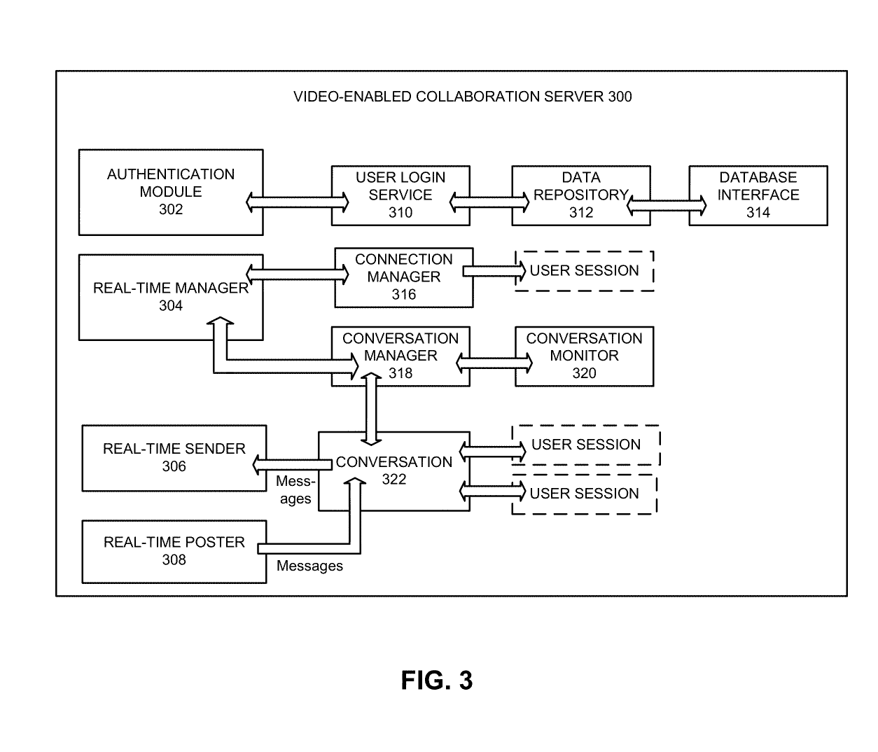

All interactions, including the sending and receiving of the “view-sync” request, between the VR client and the AR client are coordinated by a video-enabled collaboration server. FIG. 3 presents a diagram illustrating the architecture of an exemplary video-enabled collaboration server, in accordance with an embodiment of the present invention. Video-enabled collaboration server 300 includes an authentication module 302, a real-time manager 304, a real-time sender 306, and a real-time poster 308.

Authentication module 302 is responsible for handling user authentication processes, including user registration and login. In addition, authentication module 302 is involved in other aspects of user management, including adding new users or deleting existing users. In one embodiment, a web page for addition/deletion of users is provided to an administrator of the system to allow the administrator to add or delete users. In addition, a user registration page is provided to users of the system. During operation, authentication module 302 interacts with a user login service module 310; a data repository 312, which stores user registration information; and a database interface 314 in order to accomplish tasks associated with user authentication.

Real-time manager 304 is responsible for managing real-time connections between clients and the collaboration server 300. During operation, real-time manager 304 manages user sessions via a connection manager 316. In addition, real-time manager 304 also manages and monitors “conversations” (message exchanges) among the multiple clients by interacting with a conversation manager 318 and a conversation monitor 320.

Real-time sender 306 and real-time poster 308 facilitate “conversations” among the multiple clients via a conversation module 322. In one embodiment, conversation module 322 can be implemented as a chat room, enabling real-time communication among the multiple users, with each user establishing his own user session with the conversation module 322. The real-time communication includes, but is not limited to: videos, images, annotations on the videos or the images, audio conversations, and view-steering instructions. In some embodiments, the view-steering instructions (e.g., the location of a selected object and the view information of the camera in the VR environment) are sent from the expert to collaboration server 300 in a message. In further embodiments, such a message may also include a “view-sync” request sent from the VR client. The AR client can respond to the “view-sync” request by downloading the location and view information associated with the selected object and subsequently entering a “view-synchronization mode.” While in the view-synchronization mode, the AR client tracks the real-world object and overlays the view-steering widget on the scene being tracked. In addition to using JavaScript Object Notation (JSON) messages to convey the “view-sync” requests, other communication mechanisms, such as XML-RPC (remote procedure call) or various peer-to-peer communication mechanisms, can also be used to transmit data between the VR client and the AR client.

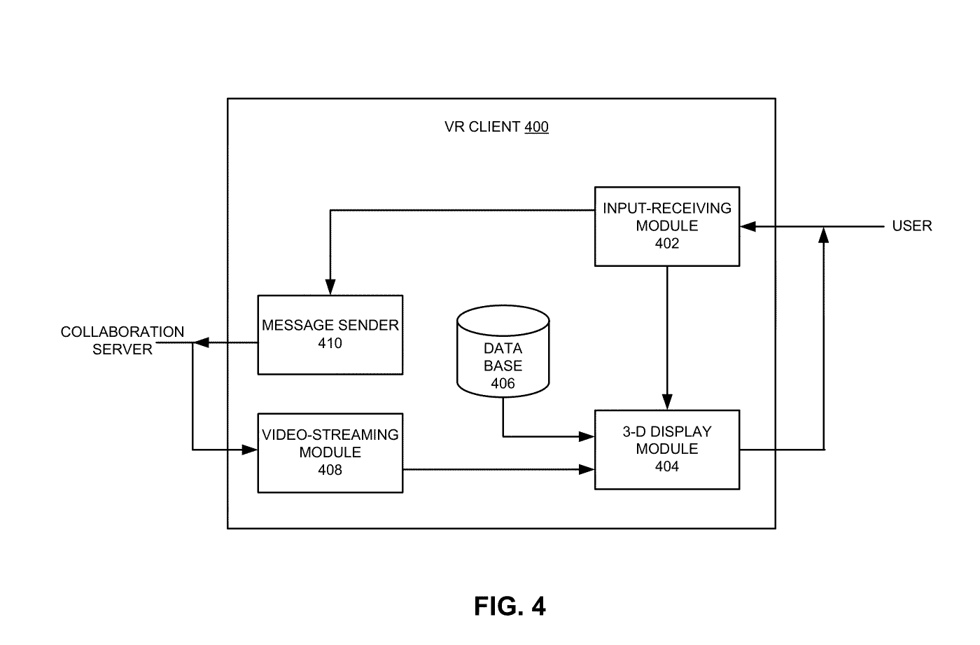

FIG. 4 presents a diagram illustrating the architecture of an exemplary virtual reality client, in accordance with an embodiment of the present invention. VR client 400 includes an input-receiving module 402, a 3-D display module 404, a database 406, a video-streaming module 408, and a message sender 410.

Input-receiving module 402 is responsible for receiving input from the user of the VR client for manipulation of the various objects in the VR environment. The user input may include positioning and rotating of components. For example, the user may click on an object in the VR environment to indicate that he is interested in such an object. The position, orientation and/or scale of the selected object may be arbitrarily adjusted in the 3-D space based on the user's desired intent. For example, the user may drag an object to the center of the display and then zoom in to view the object in more detail. In addition, the user can rotate the object in the VR environment until a desired orientation is achieved. Various mechanisms can be used to receive an input from the user, including, but not limited to: a mouse, a keyboard, a touch screen, a VR headset tracker, etc. In one embodiment, the user input may include a “view-sync” request.

3-D display module 404 displays the 3-D virtual environment based on various 3-D models, such as a CAD model, stored in database 406. In addition, 3-D display module 404 can recognize user input and update the virtual environment accordingly. For example, 3-D display module 404 can update the location and orientation of an object within the virtual environment based on the input from the user.

Video-streaming module 408 receives live video streams from the AR client via the collaboration server. These live video streams enable the expert using VR client 400 to view videos captured by the AR camera, as if “watching over the shoulders” of the novice using the AR client. These videos, or still images extracted from these videos, can also be displayed to the user by 3-D display module 404.

Message sender 410 sends out various messages, including a “sync view” request or other communication messages, to the collaboration server. In one embodiment, the location of a selected object and the view information can also be sent to the collaboration server in the form of a message, such as a JSON message.

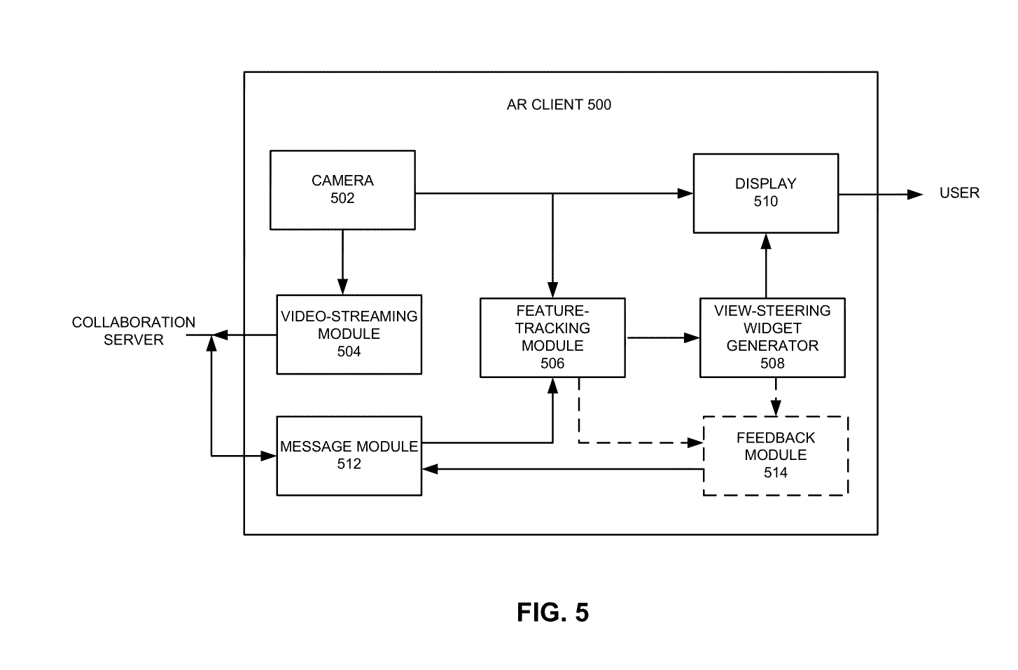

FIG. 5 presents a diagram illustrating the architecture of an exemplary augmented reality client, in accordance with an embodiment of the present invention. AR client 500 includes a camera 502, a video-streaming module 504, a feature-tracking module 506, a view-steering widget generator 508, a display 510, a message module 512, and an optional feedback module 514.

During operation, camera 502 records real-world video scenes, and video-streaming module 504 streams the videos to the collaboration server, which in turn forwards the videos or still images extracted from the videos to a VR client. Feature-tracking module 506 is responsible for extracting and tracking features from the real-world scenes in the captured videos. Certain forms of feature analysis may take place in order to determine the current camera orientation and the correspondence between objects in the VR environment and objects in the real-world scene. Note that using the 3-D model maintained by the VR client, feature-tracking module 506 is able to determine a location of a real-world object relative to the current camera view, even when such an object is currently out of the camera view.

Message module 512 is responsible for facilitating message exchanges between the novice using AR client 500 and the expert using the VR client, via the collaboration server. The messages may include regular communication messages in audio or text forms, and “view-sync” requests, which may indicate a selected object in the VR environment and the location and view information associated with the selected object.

In response to the AR user accepting the view-sync request, view-steering widget generator 508 generates a view-steering widget based on the location and view information included in the view-sync request. The generated view-steering widget is displayed by display 510. In some embodiments, the view-steering widget is overlaid on the tracked scene. When the AR user adjusts the camera location and view angle with the assistance of the view-steering widget, view-steering widget generator 508 updates or generates a new widget accordingly. For example, when the desired object is out of the camera view, view-steering widget generator 508 generates a widget in the form of peripheral dots or arrows, indicating a direction for moving the camera. However, once the desired object is in the view of the camera, as detected by feature-tracking module 506, view-steering widget generator 508 may generate a new, more precise view-steering widget based on the location and view information included in the view-sync request and the current location and orientation of the desired object and the camera. In some embodiments, this more precise view-steering widget can be a hollow polygon pipe, projecting out of the surface of the desired object. The AR user can adjust the camera in such a way that the camera is looking down the hollow pipe toward the desired object from the top of the hollow pipe.

The optional feedback module 514 allows AR client 500 to provide feedback to the VR client in a situation where the desired view may not be physically feasible. For example, when servicing a car engine, the expert using the VR client may want to view the bottom of an exhaust valve. In the VR environment where a 3-D CAD model is displayed, the expert can select the exhaust valve and rotate it to the desired view. However, once AR client 500 downloads the location and viewing angle of the exhaust valve from the collaboration server, view-steering widget generator 508 may determine that, based on physical constraints, such as the size of the camera and the available space, it is impossible for the novice user to achieve the view desired by the expert. In response, instead of generating a view-steering widget, view-steering widget generator 508 may generate a warning indicating that the desired view is not physically achievable. Feedback module 514 can then send such a warning, in the form of a message, back to the expert, via the collaboration server. Such feedback can prompt the expert to re-evaluate the situation and adjust the desired viewing angle accordingly.

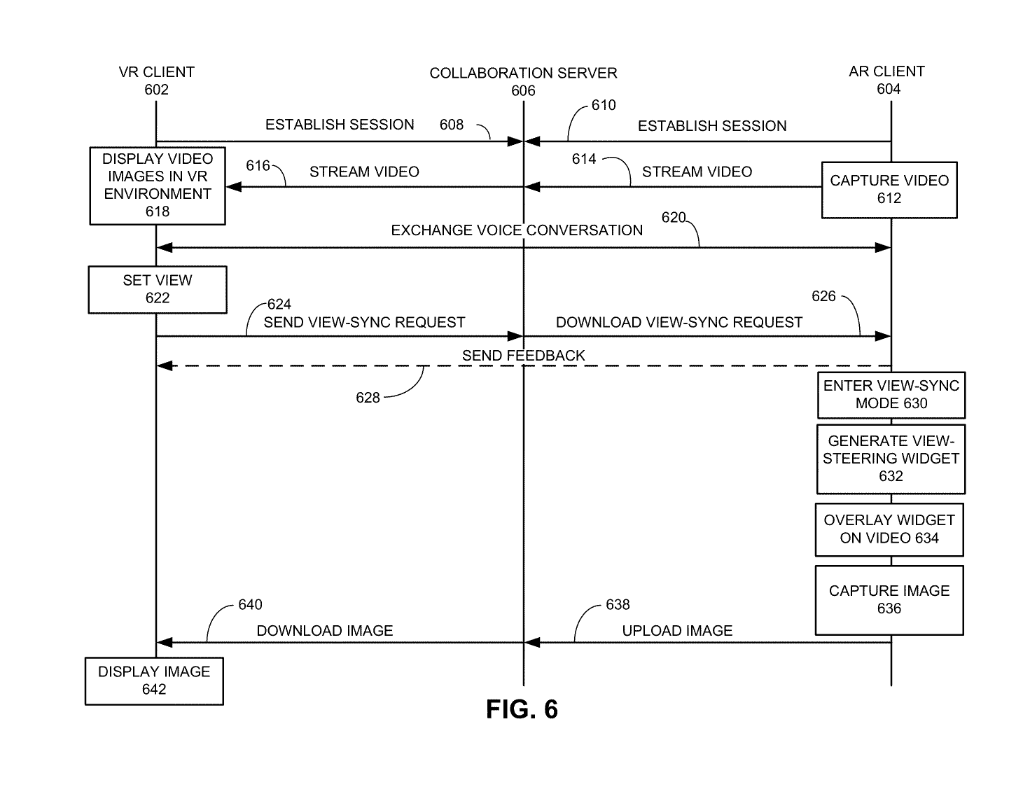

FIG. 6 presents a time-space diagram illustrating the view-steering process, in accordance with an embodiment of the present invention. During operation, an expert user of a VR client 602 and a novice user of an AR client 604 establish a live communication session between each other via a collaboration server 606 (operations 608 and 610). Note that collaboration server 606 is responsible for user authentication.

AR client 604 captures video frames reflecting the real-world scenes (operation 612), and concurrently streams the captured video frames to collaboration server 606 (operation 614). AR client 604 can be a head-mounted computer, a PC equipped with a webcam, a mobile computing device equipped with a camera, or a web-enabled wired or wireless surveillance camera.

VR client 602 streams the live video from collaboration server 606 (operation 616). VR client 602 displays the video stream or imaged extracted from the live video stream in addition to a displayed multi-dimensional VR environment (operation 618). In one embodiment, the live video may be displayed in a separate window in the VR environment. While in session, VR client 602 and AR client 604 may exchange voice conversation via collaboration server 606 (operation 620).

The expert user of VR client 602 sets a desired view in the VR environment (operation 622). The VR user can set the view by selecting an object in the VR environment and manipulating the object to express a desired viewing angle. In addition, the user can simply position his view in the VR environment without specifying a particular object. VR client 602 then sends a “view-sync” request to collaboration server 606 (operation 624). The view-sync request includes the location and orientation of the selected object and/or the view information.

AR client 604 downloads the view-sync request, which includes the location and orientation of the selected object and/or the view information (operation 626), and can optionally send feedback to VR client 602 (operation 628), indicating that the view-sync request may not be physically feasible. Subsequently, AR client 604 enters a “view-synchronization” mode (operation 630). In the view-synchronization mode, AR client 604 generates a view-steering widget based on information included in the view-sync request (operation 632), and overlays the view-steering widget on the video scene, thus assisting the user in adjusting the camera (operation 634). Note that the view-steering widget can have various forms, including but not limited to: peripheral dots, arrows, polygon pipes, gimbals, cones, avatars, etc.

Once the AR camera has been moved to the desired location, as indicated by the view-steering widget, AR client 604 performs an action, such as capturing a high-resolution image of the view (operation 636). AR client 604 subsequently uploads the image to collaboration server 606 (operation 638). VR client downloads the image from collaboration server 606 (operation 640), and then displays such an image in the VR environment for the expert (operation 642).

### Computer System

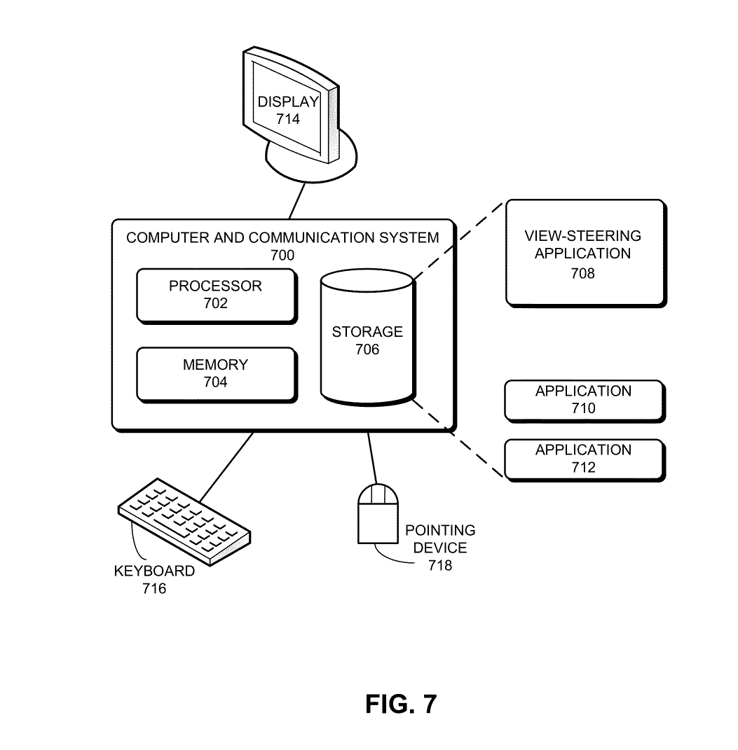

FIG. 7 illustrates an exemplary computer system for view-steering in a VR/AR combined system, in accordance with one embodiment of the present invention. In one embodiment, a computer and communication system 700 includes a processor 702, a memory 704, and a storage device 706. Storage device 706 stores a view-steering application 708, as well as other applications, such as applications 710 and 712. During operation, view-steering application 708 is loaded from storage device 706 into memory 704 and then executed by processor 702. While executing the program, processor 702 performs the aforementioned functions. Computer and communication system 700 is coupled to an optional display 714, keyboard 716, and pointing device 718.

Note that the systems and processes shown in FIGS. 1-7 are for illustration purposes only and should not limit the scope of this disclosure. In general, embodiments of the present invention provide a system for interactive display of a view-steering widget on top of a locally generated and displayed scene, with the view-steering widget being controlled by a remote client machine via a collaboration server. More specifically, a user of the remote client machine can use the view-steering widget to instruct the user of a local client machine to perform certain operations, such as adjusting location and orientation of a camera. The system architecture shown in FIG. 1 is merely exemplary. Other configurations are also possible. For example, instead of using a client machine running a VR application, it is also possible for the expert user to use a client machine running on an AR application. Instead of selecting and manipulating an object in the VR environment, the expert user may add notations that can be mapped into objects in the AR environment, such as circling a particular object. These notations and the mapping between the notations and features can be sent to the other AR client, which can then generate the view-steering widget accordingly. In addition, the novice user may also use a client machine running a VR application. The view-steering widget on top of the VR display may suggest to the novice user how to manipulate an object in the VR environment. Here, instead of adjusting a camera, the novice user may need to use a pointing device, such as a mouse, to drag and rotate the object based on the direction shown by the view-steering widget until a desired view is achieved.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-executable method for assisting view-steering from a remote client machine, the method comprising:
receiving, at a local client from a collaboration server, a view-synchronization request for synchronizing a local scene displayed on the local client with a remote scene displayed on the remote client;
generating, at the local client, a view-steering widget based on the view-synchronization request; and
displaying the view-steering widget on top of the local scene, thereby facilitating a local user of the local client to update the local scene displayed on the local client in order to match the local scene to at least a portion of the remote scene displayed on the remote client.

2. The method of claim 1, wherein the remote client runs a virtual reality (VR) application that displays the remote scene.

3. The method of claim 2, wherein the view-synchronization request comprises one or more of:
a location and an orientation of an object within the remote scene; and
view information associated with the remote scene.

4. The method of claim 1, wherein the local client runs an augmented reality (AR) application, and wherein the local scene comprises at least a video scene captured by a camera coupled to the local client.

5. The method of claim 4, wherein displaying the view-steering widget involves overlaying the view-steering widget on the video scene, and wherein the view-steering widget indicates one or more of: a direction of the camera, and a distance of the camera.

6. The method of claim 1, wherein the view-steering widget includes one or more of:
peripheral dots;
an arrow;
a gimbal;
a mini map;
a polygon pipe; and
a cone.

7. The method of claim 1, further comprising:
in response to determining that the local scene has been updated to match the portion of the remote scene, transmitting an image of the local scene to the remote client.

8. A non-transitory computer-readable storage medium storing instructions that when executed by a computer cause the computer to perform a method for assisting view-steering from a remote client machine, the method comprising:
receiving, at a local client from a collaboration server, a view-synchronization request for synchronizing a local scene displayed on the local client with a remote scene displayed on the remote client;
generating, at the local client, a view-steering widget based on the view-synchronization request; and
displaying the view-steering widget on top of the local scene, thereby facilitating a local user of the local client to update the local scene displayed on the local client in order to match the local scene to at least a portion of the remote scene displayed on the remote client.

9. The computer-readable storage medium of claim 8, wherein the remote client runs a virtual reality (VR) application that displays the remote scene.

10. The computer-readable storage medium of claim 9, wherein the view-synchronization request comprises one or more of:
a location and an orientation of an object within the remote scene; and
view information associated with the remote scene.

11. The computer-readable storage medium of claim 8, wherein the local client runs an augmented reality (AR) application, and wherein the local scene comprises at least a video scene captured by a camera coupled to the local client.

12. The computer-readable storage medium of claim 11, wherein displaying the view-steering widget involves overlaying the view-steering widget on the video scene, and wherein the view-steering widget indicates one or more of: a direction of the camera, and a distance of the camera.

13. The computer-readable storage medium of claim 8, wherein the view-steering widget includes one or more of:
peripheral dots;
an arrow;
a gimbal;
a mini map;
a polygon pipe; and
a cone.

14. The computer-readable storage medium of claim 8, wherein the method further comprises:
in response to determining that the local scene has been updated to match the portion of the remote scene, transmitting an image of the local scene to the remote client.

15. A computer system, comprising:
a processor;
a receiving mechanism configured to receive, from a collaboration server, a view-synchronization request for synchronizing a local scene displayed on a local client with a remote scene displayed on a remote client;
a widget generator configured to generate a view-steering widget based on the view-synchronization request; and
a displaying mechanism configured to display the view-steering widget on top of the local scene, thereby facilitating a user of the local client to update the local scene in order to match the local scene to at least a portion of the remote scene displayed on the remote client.

16. The computer system of claim 15, wherein the remote client runs a virtual reality (VR) application that displays the remote scene.

17. The computer system of claim 16, wherein the view-synchronization request comprises one or more of:
a location and an orientation of an object within the remote scene; and
view information associated with the remote scene.

18. The computer system of claim 15, wherein the local client runs an augmented reality (AR) application, and wherein the local scene comprises at least a video scene captured by a camera coupled to the local client.

19. The computer system of claim 18, wherein displaying the view-steering widget involves overlaying the view-steering widget on the video scene, and wherein the view-steering widget indicates one or more of: a direction of the camera, and a distance of the camera.

20. The computer system of claim 15, wherein the view-steering widget includes one or more of:
peripheral dots;
an arrow;
a gimbal;
a mini map;
a polygon pipe; and
a cone.

21. The computer system of claim 15, further comprising a transmit mechanism configured to, in response to determining that the local scene has been updated to match the portion of the remote scene, transmit an image of the local scene to the remote client.
